(19) United States
(12) Patent Application Publication
(10) Pub. No.: US 2026/0127977 A1
(43) Pub. Date: May 7, 2026

(54) System and Method for Training Medical Providers in Obesity and Cardiometabolic Health Management Using Artificial Intelligence and Competency-Based Assessments

(71) Applicant: Intellihealth, Inc., New Cannan, CT (US)

(72) Inventors: David H. Bass, San Francisco, CA (US); Leon Igel, Brookville, NY (US); Christina Lorenzo, Steamboat Springs, CO (US); Cheryl Pegus, Henderson, NV (US); Nathan Lesch, Minneapolis, MN (US); Guadalupe Minero, Poway, CA (US); Venkateswaran Suriyanarayanan, San Jose, CA (US)

(21) Appl. No.: 19/375,071

(22) Filed: Oct. 30, 2025

Related U.S. Application Data
(60) Provisional application No. 63/716,082, filed on Nov. 4, 2024.

(51) Int. Cl. G09B 19/00; G06N 3/02; G06Q 10/0639; G09B 5/02

(52) U.S. Cl. CPC G09B 19/00; G06N 3/02; G06Q 10/06398; G09B 5/02

(57) ABSTRACT

A system for training medical providers in obesity management and obesity-related comorbidities includes a user device presenting a conversational interface to a medical provider, an application server managing user sessions, a database server storing user data including course completion records and clinical performance audits, and a learning management system server delivering educational modules based on established competencies. An artificial intelligence server processes queries from the medical provider and provides personalized medical advice using a large language model trained on obesity-related medical content including obesity physiology, pharmacotherapy, and patient management. The artificial intelligence server receives outcome information related to patient health metrics following the personalized medical advice and retrains the large language model based on the outcome information. A performance audit system monitors clinical documentation, prescribing patterns, and patient outcomes of the medical provider to ensure ongoing compliance and performance improvements.

### CROSS REFERENCE TO RELATED APPLICATIONS

This application claims the beneift and priority of US provisional application 63/716,064, filed on Nov. 4, 2024, US provisional application 63/716,074, filed on Nov. 4, 2024, and US provisional application 63/716,082, filed on Nov. 4, 2024 including all references and appendicies cited therein in their entireties, for all purposes, as if fully set forth herein.

### FIELD

The present disclosure relates to systems and methods for training medical providers in obesity medicine and cardiometabolic health management using artificial intelligence, large language models, and competency-based assessment frameworks.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for training medical providers in obesity management and obesity-related comorbidities. The system also includes a user device configured to present a conversational interface to a medical provider; an application server in communication with the user device, the application server configured to manage user sessions and process requests from the user device; a database server in communication with the application server, the database server configured to store user data may include course completion records, knowledge assessment results, and clinical performance audits; a learning management system server in communication with the application server, the learning management system server configured to deliver educational modules based on established competencies and to track user progress through the educational modules; an artificial intelligence server in communication with the application server, the artificial intelligence server configured to process queries from the medical provider and provide personalized medical advice using a large language model trained on obesity-related medical content may include obesity physiology, pharmacotherapy, and patient management, where the artificial intelligence server is further configured to receive outcome information related to patient health metrics following the personalized medical advice and to retrain the large language model based on the outcome information; and a performance audit system in communication with the application server, the performance audit system configured to monitor clinical documentation, prescribing patterns, and patient outcomes of the medical provider. Other embodiments of this aspect include corresponding computer systems, apparatus, and computer programs recorded on one or more computer storage devices, each configured to perform the actions of the methods.

Implementations may include one or more of the following features. The system where the database server may include a combination of relational databases and noSQL databases. The system may include a cloud hosting layer providing scalable storage and processing capabilities for the application server, the database server, the learning management system server, the artificial intelligence server, and the performance audit system. The system may include a security layer compliant with health insurance portability and accountability act regulations, the security layer configured to protect data through encryption for data at rest and in transit. The system may include a collaboration server configured to facilitate real-time communication between the medical provider and subject matter experts through health insurance portability and accountability act compliant chat channels and video conferencing. The system may include a feedback and frequently asked questions module in communication with the collaboration server, the feedback and frequently asked questions module configured to compile questions and responses to create a dynamic knowledge base. The system may include an analytics server in communication with the application server, the analytics server configured to process data may include course completions, assessment scores, and clinical practice audits to generate insights into training effectiveness. The analytics server is configured to apply machine learning algorithms to identify knowledge gaps and inform personalized feedback for the medical provider. The learning management system server is configured to administer a series of educational modules based on obesity medicine educational collaborative competencies during an onboarding process. The learning management system server is configured to conduct assessments at a beginning of the onboarding process, after the onboarding process, and at a designated time post-onboarding to evaluate competencies of the medical provider in obesity-related domains. The learning management system server is configured to perform a skills assessment to verify proficiency of the medical provider in performing tasks within an electronic medical record system. The performance audit system is configured to evaluate quality of patient care and identify areas where additional training is required and trigger educational interventions. The obesity-related medical content further may include type 2 diabetes, pre-bariatric surgery care, post-bariatric surgery care, metabolic dysfunction-associated steatohepatitis, metabolic dysfunction-associated steatotic liver disease, nonalcoholic fatty liver disease, non-alcoholic steatohepatitis, women's health, polycystic ovary syndrome, and menopausal weight gain. Implementations of the described techniques may include hardware, a method or process, or computer software on a computer-accessible medium.

One general aspect includes a method for training medical providers in obesity treatment and obesity-related comorbidities. The method also includes administering, by a learning management system server, a series of educational modules based on obesity medicine educational collaborative competencies during an onboarding process for a new medical provider; conducting, by the learning management system server, assessments at a beginning of the onboarding process, after the onboarding process, and at a designated time post-onboarding to evaluate competencies of the new medical provider in obesity-related domains; performing, by the learning management system server, a skills assessment to verify proficiency of the new medical provider in performing tasks within an electronic medical record system and clinical protocols; providing, by an artificial intelligence server, tailored remedial education based on gaps identified during a knowledge assessment; and continuously auditing, by a performance audit system, clinical documentation, prescriptions, and patient interactions of the new medical provider to ensure ongoing compliance and performance improvements. Other embodiments of this aspect include corresponding computer systems, apparatus, and computer programs recorded on one or more computer storage devices, each configured to perform the actions of the methods.

Implementations may include one or more of the following features. The method may include processing, by the artificial intelligence server, queries from the new medical provider using a large language model trained on obesity-related medical content. The method may include retraining, by the artificial intelligence server, the large language model based on outcome information related to patient health metrics to improve accuracy of future advice. The obesity-related domains may include obesity physiology, diabetes management, bariatric surgery care, and cardiometabolic comorbidities. Implementations of the described techniques may include hardware, a method or process, or computer software on a computer-accessible medium.

One general aspect includes a system for training a medical provider in treating obesity and obesity-related comorbidities. The system also includes at least one processor; and a memory storing instructions that, when executed by the at least one processor, cause the system to: receive, from the medical provider via a user-facing application with a conversational interface, a query; provide advice to the medical provider based on a large language model trained on training content may include obesity physiology, obesity pathophysiology, type 2 diabetes, pre-bariatric surgery care, post-bariatric surgery care, metabolic dysfunction-associated steatohepatitis, metabolic dysfunction-associated steatotic liver disease, nonalcoholic fatty liver disease, non-alcoholic steatohepatitis, women's health, polycystic ovary syndrome, and menopausal weight gain; receive outcome information based on the advice, where the outcome information may include at least one of biomarker information, information about a medication, or diet type information; and retrain the large language model based on the outcome information for improved advice for treating a comorbid condition. Other embodiments of this aspect include corresponding computer systems, apparatus, and computer programs recorded on one or more computer storage devices, each configured to perform the actions of the methods.

Implementations may include one or more of the following features. The system where the large language model may include a neural network. The conversational interface is configured to understand and analyze the query with medical accuracy. Implementations of the described techniques may include hardware, a method or process, or computer software on a computer-accessible medium.

### BRIEF DESCRIPTION OF THE DRAWINGS

FIG. 1 shows an example computing architecture of a cloud-based system for training and assessing medical providers in obesity management and obesity-related comorbidities.

FIG. 2 shows an example method for training medical providers in obesity treatment and obesity-related comorbidities through competency-based assessments and continuous auditing.

FIG. 3 shows an example method for operating an artificially intelligent system that receives queries from medical providers, provides advice based on a trained large language model, receives outcome information, and retrains the model.

FIG. 4 shows an example method for implementing an artificial intelligence retraining feedback loop that correlates advice provided with clinical outcomes achieved and continuously improves the large language model.

FIG. 5 shows an example method for implementing onboarding and initial competency verification workflow from initial assessment through remedial education completion.

FIG. 6 shows an example method for implementing post-onboarding monitoring and privilege expansion workflow including a decision point for granting full privileges or requiring additional remediation.

FIG. 7 is a schematic of an example computer system that can be used to implement embodiments of the present disclosure.

### DETAILED DESCRIPTION OF EXAMPLE EMBODIMENTS

The present disclosure addresses a critical gap in medical education by providing a comprehensive system for training medical providers in obesity management and cardiometabolic health conditions. Despite the prevalence of obesity affecting approximately seventy-five percent of adults in the United States with elevated body mass index values exceeding twenty-five, existing certification pathways lack mandatory clinical training requirements. The vast majority of medical providers who seek to demonstrate proficiency in obesity medicine pursue certification through the American Board of Obesity Medicine examination. Qualification for this examination follows one of two pathways: a fellowship pathway or a continuing medical education pathway. Approximately ninety-nine percent of applicants fulfill requirements through the continuing medical education pathway, which requires only sixty continuing medical education credit hours on obesity topics without any clinical training component. This stands in contrast to most other subspecialty board examinations that mandate supervised clinical experience. Consequently, the majority of board-certified obesity medicine clinicians possess limited practical experience delivering advanced obesity medicine care, creating a substantial competency gap between certification and clinical proficiency.

The present disclosure introduces a structured training architecture that combines multiple technological components to deliver competency-based education with continuous performance assessment. The system integrates educational content delivery, skills verification, knowledge assessment, and ongoing clinical audit functions within a unified cloud-based platform. Educational modules are based on nationally and internationally recognized Obesity Medicine Educational Collaborative competencies, ensuring standardized knowledge acquisition across multiple obesity-related domains including obesity physiology, obesity pathophysiology, diabetes management, bariatric surgery care, metabolic dysfunction-associated steatohepatitis, metabolic dysfunction-associated steatotic liver disease, nonalcoholic fatty liver disease, non-alcoholic steatohepatitis, women's health, polycystic ovary syndrome, menopausal weight gain, and cardiometabolic comorbidities. The training protocol establishes a graduated privilege expansion model wherein new medical providers systematically demonstrate competence before assuming full clinical responsibilities.

An example aspect of the present disclosure is the integration of artificial intelligence to provide personalized educational interventions. The system employs a large language model trained on obesity-related medical content to process queries from medical providers through a conversational interface and deliver contextually relevant medical guidance. The artificial intelligence component analyzes clinical documentation, prescribing patterns, and patient outcomes to identify knowledge gaps and trigger targeted remedial education. The large language model undergoes continuous retraining based on outcome information, including patient health metrics and treatment effectiveness data, creating a feedback loop that improves the accuracy and clinical relevance of future advice.

The system implements graduated privilege expansion through sequential competency verification. New providers complete self-assessment competencies at onboarding initiation, onboarding completion, and designated intervals during clinical practice. Skills assessments verify proficiency in electronic medical record systems and proprietary software before providers assume full clinical responsibilities. A performance audit system continuously monitors clinical documentation quality, prescribing patterns, and patient interaction records, enabling real-time identification of areas requiring additional training. This multi-layered assessment approach ensures that certified providers possess both theoretical knowledge and practical clinical competence before treating patients independently.

The architecture further incorporates collaboration tools and dynamic knowledge base generation. Real-time communication channels enable medical providers to consult subject matter experts through compliant messaging and video conferencing. Questions and responses from these interactions populate a frequently asked questions repository that supports onboarding efficiency for subsequent providers. Analytics components apply machine learning algorithms to aggregate data across course completions, assessment scores, and clinical practice audits, generating insights into training effectiveness and informing content optimization decisions.

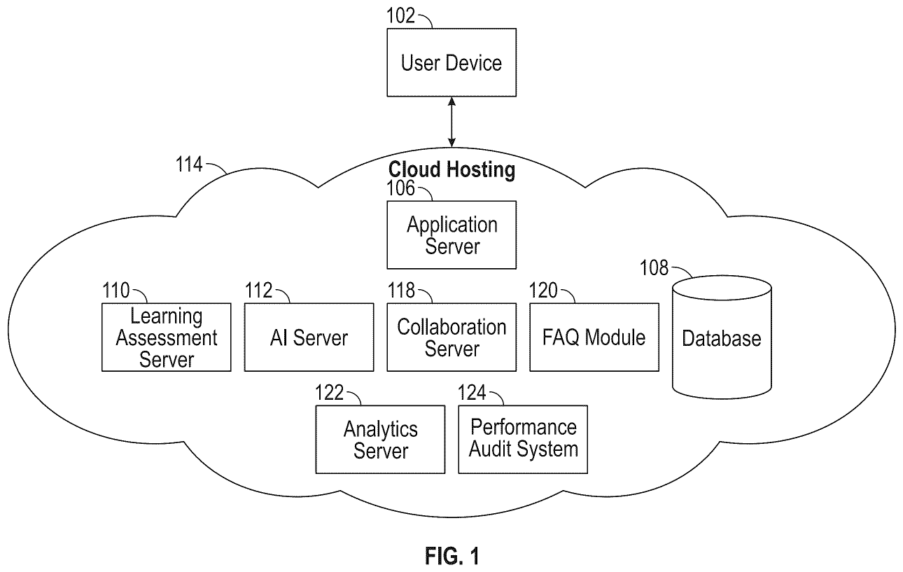

Referring to FIG. 1, an example computing architecture of system 100 of the present disclosure utilizes a cloud-based client-server computing architecture to facilitate the training and assessment of medical providers in obesity management and obesity-related comorbidities. Each user accesses system 100 via a personal computing device such as a laptop, tablet, or smartphone, collectively referenced as user device 102, which communicates with system 100 through a web browser or dedicated application. The user interface on user device 102 allows the medical provider to interact with the learning management system, review course materials, complete assessments, and receive feedback. A local data handling module within user device 102 manages operations such as inputting data, rendering the interface, and navigating sessions, while primary processing occurs on the server side.

As shown in FIG. 1, application server 106 manages user sessions, processes requests from user device 102, and delivers educational content and assessments. Application server 106 executes business logic associated with course delivery, progress tracking, and personalized feedback. Database server 108 stores user data, including course completion records, knowledge assessment results, and clinical performance audits. Database server 108 handles structured data such as provider profiles, course metadata, and performance analytics using a combination of relational databases and NoSQL databases, although other database types known to those of ordinary skill in the art may be substituted.

Learning management system server 110 hosts the educational modules and manages tasks related to content delivery, module progression, and competency assessments. Learning management system server 110 tracks user progress and generates reports based on activity, ensuring compliance with competency-based models. Artificial intelligence server 112 processes user queries and provides personalized medical advice using a large language model or neural network trained on obesity-related medical content, including physiology, pharmacotherapy, intensive therapeutic interventions, and patient management. Artificial intelligence server 112 continuously updates its model based on user interactions and feedback to improve the relevance and accuracy of its responses.

System 100 operates on cloud hosting layer 114, which provides scalable storage and processing capabilities. Cloud hosting layer 114 enables dynamic workload balancing, secure data storage, and continuous system uptime, supporting multiple concurrent users without performance degradation. A security layer, compliant with Health Insurance Portability and Accountability Act regulations, protects sensitive medical and personal data through encryption for data at rest and in transit, role-based access controls, and logging mechanisms to monitor system activity.

Collaboration server 118 facilitates real-time communication between medical providers and subject matter experts, integrating tools such as Health Insurance Portability and Accountability Act compliant chat channels, video conferencing for educational sessions such as lunch and learn meetings, and live question and answer functionalities. Feedback and frequently asked questions module 120 compiles questions and responses from these interactions to create a dynamic knowledge base that supports ongoing training and improves the onboarding process for new users.

Analytics server 122 processes data from user activities such as course completions, assessment scores, patient chart reviews, and clinical practice audits. Analytics server 122 applies machine learning algorithms to generate insights into user behavior, training effectiveness, and areas where knowledge gaps exist. These insights inform personalized feedback for users and guide future content optimization. Performance audit system 124 monitors user behavior, prescribing patterns, and clinical documentation accuracy. Performance audit system 124 evaluates the quality of patient care and identifies areas where additional training may be required, triggering appropriate educational interventions as necessary.

In this architecture, each component works in coordination to deliver a seamless, personalized, and secure educational experience to medical providers using system 100. User device 102 allows providers to access training content, while application server 106, database server 108, learning management system server 110, artificial intelligence server 112, collaboration server 118, feedback and frequently asked questions module 120, analytics server 122, and performance audit system 124 manage, assess, and deliver content efficiently and securely. Cloud hosting layer 114 ensures system scalability and performance, while real-time communication tools such as collaboration server 118 and analytics server 122 provide continuous feedback to enhance learning outcomes.

The architecture illustrated in FIG. 1 represents one example configuration, and various components may be consolidated or modified depending on implementation requirements. For instance, application server 106 and learning management system server 110 could be combined into a single server responsible for both user session management and content delivery, simplifying the server infrastructure. Similarly, artificial intelligence server 112 could be integrated with analytics server 122, allowing the same server to process user queries, generate personalized medical advice, and analyze user behavior for feedback purposes. Collaboration server 118 and feedback and frequently asked questions module 120 could also be consolidated, allowing real-time communication functionalities and the creation of a knowledge base to be managed from a unified interface. This flexibility allows system 100 to be tailored to specific scalability, performance, or cost considerations while maintaining its core functionality.

The training process begins with administration of Obesity Medicine Educational Collaborative competency assessments during new provider onboarding. These competency assessments establish each medical provider's self-reported training needs across multiple obesity-related domains. The competency assessments are repeated at the conclusion of onboarding and again at a designated interval following onboarding, such as three months after joining clinical practice. Both the medical provider and the medical provider's supervisor complete the competency assessments at the conclusion of onboarding and at the designated post-onboarding interval, enabling comparison between self-assessment and managerial evaluation to identify discrepancies in perceived versus actual competency levels.

Following completion of initial educational modules, learning management system server 110 administers a skills assessment to evaluate new medical providers at the conclusion of onboarding. The skills assessment verifies that medical providers can perform all necessary operational tasks within the electronic medical record system, proprietary software platforms, and clinical workflows required for daily practice. Tasks evaluated during the skills assessment include ordering medications, ordering laboratory tests, updating baseline patient weights and highest recorded weights, validating anti-obesity medication prescriptions, executing referral processes, customizing video conferencing interfaces for patient appointments, accessing ancillary learning resources, managing patient no-show protocols, maintaining appropriate clinical visit cadence, and navigating learning management system server 110 for ongoing education. This operational proficiency verification ensures that medical providers possess the technical facility to execute clinical decisions within system 100 infrastructure before engaging in unsupervised patient care.

Learning management system server 110 further administers a proctored knowledge assessment to confirm that medical providers possess the medical knowledge necessary to treat patients with obesity and obesity-related comorbidities. The knowledge assessment evaluates understanding of obesity physiology, pharmacotherapy options, intensive therapeutic interventions, patient management strategies, treatment of type two diabetes, pre-bariatric surgery evaluation and preparation, post-bariatric surgery management, metabolic dysfunction-associated liver conditions, women's health considerations including polycystic ovary syndrome and menopausal weight gain, and management of cardiometabolic comorbidities. Following completion of the knowledge assessment, analytics server 122 identifies specific domains where the medical provider demonstrated knowledge gaps based on assessment performance. Tailored remedial education is then provided through learning management system server 110 to address the identified deficiencies, with educational content customized to the specific domains requiring additional study. This individualized intervention ensures that each medical provider receives targeted instruction addressing their particular knowledge weaknesses rather than requiring repetition of material already mastered.

Artificial intelligence server 112 provides personalized educational interventions and real-time clinical guidance through a conversational interface presented on user device 102. The large language model or neural network within artificial intelligence server 112 processes queries from medical providers and delivers contextually relevant medical guidance based on training on obesity-related medical content. Artificial intelligence server 112 analyzes clinical documentation, prescribing patterns, and patient outcomes stored in database server 108 to identify knowledge gaps and trigger targeted remedial education delivered through learning management system server 110. Artificial intelligence server 112 continuously updates its large language model or neural network based on outcome information, including patient health metrics, biomarker data, medication effectiveness information, dietary intervention results, and treatment effectiveness data across multiple therapeutic modalities. This creates a feedback loop that improves the accuracy and clinical relevance of future advice by incorporating real-world treatment outcomes into the model's training corpus. As medical providers interact with the conversational interface through user device 102 and subsequently treat patients, analytics server 122 correlates the advice provided by artificial intelligence server 112 with the clinical outcomes achieved, enabling the large language model to refine its recommendations based on empirical effectiveness rather than theoretical guidelines alone.

Performance audit system 124 implements performance monitoring through continuous clinical documentation audits beginning immediately upon a medical provider's transition to active patient care. During the first month of clinical practice, performance audit system 124 conducts weekly recorded observational appointment audits for all new medical providers. These audits involve review of patient interactions, clinical notes, prescription decisions, and billing accuracy stored in database server 108. Following each audit, the medical provider participates in individual review sessions facilitated through collaboration server 118 to discuss documentation quality, prescribing appropriateness, adherence to established protocols, and billing compliance. This intensive early monitoring identifies problematic patterns before they become ingrained habits and provides immediate corrective feedback when deviations from best practices occur.

Beyond the initial month of intensive monitoring, performance audit system 124 maintains ongoing performance oversight through multiple mechanisms. Performance audit system 124 continuously monitors clinical documentation quality, prescribing patterns, and patient interaction records stored in database server 108, enabling identification of areas requiring additional training. Biweekly individual meetings between medical providers and supervisory clinicians, facilitated through collaboration server 118, review documentation practices and prescribing patterns, ensuring sustained adherence to quality standards. For nurse practitioners, collaboration server 118 schedules standardized monthly collaborating physician meetings to satisfy state regulatory requirements and facilitate case review with supervising physicians. These structured touchpoints create multiple opportunities for performance assessment and intervention before quality issues affect patient care outcomes.

Performance audit system 124 implements a comprehensive prescription review protocol to assess prescribing patterns of each medical provider and evaluate protocol adherence and cost-effectiveness. Monthly reviews examine all prescriptions written by medical providers and stored in database server 108, analyzing medication selection, dosing appropriateness, consideration of formulary restrictions, prior authorization management, and alignment with evidence-based treatment algorithms. This systematic review identifies medical providers who consistently select more expensive therapeutic options when equally effective lower-cost alternatives exist, who demonstrate inappropriate dose escalation patterns, or who fail to adequately consider contraindications and drug interactions. The prescription review data feeds back into learning management system server 110, triggering delivery of educational modules addressing identified prescribing deficiencies.

Analytics server 122 monitors patient satisfaction metrics and patient-reported outcomes to assess the quality of care delivered by each medical provider. Monthly monitoring includes review of net promoter scores, patient satisfaction survey responses, and qualitative patient comments regarding their clinical experiences stored in database server 108. This patient-centered feedback provides insight into aspects of care delivery not captured by clinical documentation review alone, such as communication effectiveness, shared decision-making quality, and patient perception of provider expertise and empathy. Medical providers with consistently lower patient satisfaction scores receive coaching on communication techniques, patient engagement strategies, and approaches to address common patient concerns that arise during obesity treatment, delivered through learning management system server 110 or facilitated through collaboration server 118.

Collaboration server 118 provides real-time communication channels to support medical providers during clinical decision-making. A dedicated communication channel compliant with Health Insurance Portability and Accountability Act regulations enables medical providers to pose clinical questions through user device 102 and receive responses from subject matter experts in real time. This immediate access to expertise addresses knowledge gaps encountered during actual patient care rather than requiring medical providers to defer clinical decisions until formal educational sessions occur. Questions submitted through collaboration server 118 and the corresponding expert responses are compiled by feedback and frequently asked questions module 120 into a dynamic frequently asked questions repository stored in database server 108. This knowledge base grows continuously as medical providers encounter novel clinical scenarios, creating a searchable resource that supports rapid onboarding of new medical providers by providing immediate access to institutional knowledge accumulated from prior clinical experiences.

Collaboration server 118 schedules recurring educational sessions to support ongoing professional development beyond the initial onboarding period. Weekly educational sessions provide forums for case review, discussion of challenging clinical scenarios, presentation of recent obesity medicine research findings, and instruction on newly available therapeutic options. Office hours sessions provide dedicated time for medical providers to consult with subject matter experts regarding specific patient cases without the time pressure of real-time clinical decision-making. These recurring educational touchpoints ensure that medical providers maintain current knowledge as obesity medicine evolves and that the collective clinical experience of the medical provider team is shared broadly rather than remaining siloed with individual practitioners.

Learning management system server 110 houses a curated compendium of educational courses and articles that medical providers are required to complete as part of ongoing professional development. Course content covers obesity physiology and pathophysiology, type two diabetes management, pre-bariatric surgery evaluation and preparation, post-bariatric surgery care including management of nutritional deficiencies and surgical complications, metabolic dysfunction-associated steatohepatitis, metabolic dysfunction-associated steatotic liver disease, nonalcoholic fatty liver disease, non-alcoholic steatohepatitis, women's health considerations in obesity management, polycystic ovary syndrome, menopausal weight gain, practical prescribing methodologies, nutrition counseling techniques, and physical activity prescription. Learning management system server 110 tracks completion of required courses and generates reports identifying medical providers who have not fulfilled continuing education requirements within designated timeframes.

Learning management system server 110 provides standardized operating procedures, workflow documentation, and clinical scribes to support consistent execution of routine clinical tasks. Documentation covers medication ordering protocols, laboratory test ordering guidelines, procedures for updating baseline and highest recorded patient weights, anti-obesity medication validation requirements, referral processes for surgical consultation or specialist management of comorbidities, configuration of video conferencing environments for telehealth appointments, access procedures for ancillary learning resources, protocols for managing patient no-shows, guidance on appropriate clinical visit cadence for different patient populations and treatment phases, and navigation instructions for learning management system server 110. This comprehensive procedural documentation reduces variability in operational task execution and minimizes the risk that medical providers will develop idiosyncratic workflows that deviate from established best practices.

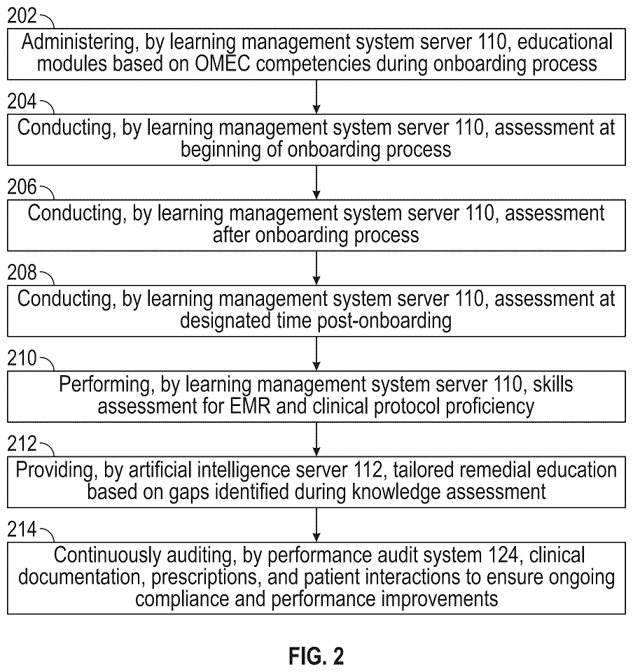

The following sections pertain to methods that can be executed with the system disclosed in FIG. 1, therefore each method will make reference to FIG. 1 collectively. Referring to FIG. 2, an example method for training medical providers in obesity treatment and obesity-related comorbidities is illustrated. The method begins with step 202, in which learning management system server 110 administers a series of educational modules based on Obesity Medicine Educational Collaborative competencies during an onboarding process for a new medical provider. The educational modules cover multiple obesity-related domains including obesity physiology, obesity pathophysiology, diabetes management, bariatric surgery care, and cardiometabolic comorbidities. Learning management system server 110 delivers the educational modules to user device 102 where the new medical provider accesses the content through a web browser or dedicated application. Database server 108 stores progress data indicating which educational modules the new medical provider has completed and tracks time spent on each module.

Step 204 establishes a baseline understanding of the new medical provider's existing knowledge through an initial competency assessment. Learning management system server 110 conducts this assessment at the beginning of the onboarding process to evaluate competencies in obesity-related domains and identify areas requiring focused instruction. The assessment queries the new medical provider regarding their self-reported competency levels across multiple domains including obesity physiology, pharmacotherapy, intensive therapeutic interventions, patient management, diabetes treatment, bariatric surgery management, and cardiometabolic comorbidity management. Database server 108 stores the initial assessment results for subsequent comparison with post-onboarding assessments.

Following completion of the educational modules, learning management system server 110 conducts a post-onboarding assessment at step 206 to evaluate competencies of the new medical provider in obesity-related domains. This assessment measures knowledge acquisition achieved during the onboarding process and identifies any remaining competency gaps requiring remediation. The post-onboarding assessment is completed by both the new medical provider as a self-assessment and by the new medical provider's manager as an external evaluation. Analytics server 122 compares the self-assessment results with the manager assessment results to identify discrepancies between the new medical provider's perceived competency and the manager's evaluated competency. Significant discrepancies indicate areas where the new medical provider may overestimate or underestimate their own abilities, triggering focused discussion during individual feedback sessions.

The method includes step 208, which evaluates whether competencies have been maintained during independent clinical practice. Learning management system server 110 conducts an assessment at a designated time post-onboarding, which may be three months after the new medical provider begins active clinical practice, although other intervals such as two months, four months, or six months may be employed depending on the complexity of the clinical environment and the pace of the new medical provider's development. This delayed assessment determines whether real-world patient care experience has revealed additional knowledge gaps not apparent during the controlled onboarding environment. Both the new medical provider and the manager complete this delayed assessment, enabling continued monitoring of competency development over time.

At step 210, learning management system server 110 performs a skills assessment to verify proficiency of the new medical provider in performing tasks within an electronic medical record system and clinical protocols. The skills assessment differs from the knowledge assessment in that it evaluates operational proficiency rather than theoretical understanding. The new medical provider must demonstrate actual task execution including ordering medications through the electronic medical record system, ordering laboratory tests, updating baseline patient weights and highest recorded weights in patient records, validating anti-obesity medication prescriptions to ensure appropriate indications and contraindication screening, executing referral processes for surgical consultation or specialist management, customizing video conferencing interfaces for telehealth appointments, accessing ancillary learning resources, managing patient no-show protocols, maintaining appropriate clinical visit cadence, and navigating learning management system server 110 to access educational content. Learning management system server 110 presents simulated clinical scenarios requiring the new medical provider to execute these tasks while the system monitors whether each task is completed correctly and efficiently. Database server 108 stores skills assessment results indicating which tasks the new medical provider can perform proficiently and which tasks require additional training.

Tailored remedial education is provided at step 212 based on gaps identified during the knowledge assessment. Following completion of the knowledge assessment administered by learning management system server 110, analytics server 122 analyzes the assessment results stored in database server 108 to identify specific obesity-related domains where the new medical provider demonstrated insufficient knowledge. Analytics server 122 generates a prioritized list of knowledge gaps ranked by severity and clinical importance. Artificial intelligence server 112 receives the prioritized knowledge gap list and selects educational content from learning management system server 110 that addresses the identified deficiencies. The selection process performed by artificial intelligence server 112 considers the new medical provider's learning history, preferred learning modalities, available time for remediation, and the clinical urgency of acquiring knowledge in each deficient domain. Artificial intelligence server 112 may select video lectures, interactive case studies, reading materials, or practical exercises depending on the nature of the knowledge gap and the learning approach most likely to be effective for the particular new medical provider. The tailored remedial education is delivered to the new medical provider through user device 102, and learning management system server 110 tracks completion of the remedial educational activities.

Performance audit system 124 continuously audits clinical documentation, prescriptions, and patient interactions at step 214 to ensure ongoing compliance and performance improvements. The continuous auditing process begins immediately when the new medical provider transitions to active patient care and continues throughout the medical provider's employment. Performance audit system 124 monitors multiple aspects of clinical practice including documentation completeness, documentation accuracy, adherence to established clinical protocols, prescription appropriateness, medication selection rationale, dose escalation patterns, consideration of drug interactions and contraindications, patient communication quality, shared decision-making processes, and adherence to billing compliance requirements. Performance audit system 124 retrieves clinical documentation, prescription records, and patient interaction data from database server 108 and applies rule-based algorithms and machine learning models to identify deviations from best practices. When performance audit system 124 identifies deficiencies, it triggers alerts to supervisory personnel through collaboration server 118 and automatically initiates delivery of targeted educational interventions through learning management system server 110. The continuous nature of step 214 ensures that performance monitoring does not cease after the onboarding period concludes but rather persists as an ongoing quality assurance mechanism throughout the medical provider's clinical practice.

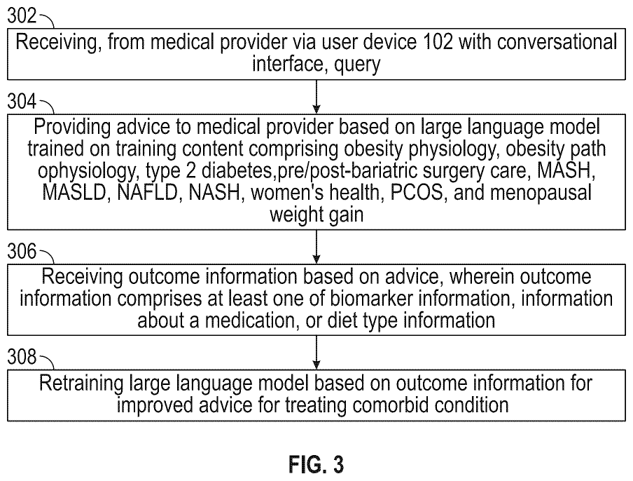

Referring to FIG. 3, an example method for operating an artificially intelligent system for training a medical provider in treating obesity and obesity-related comorbidities is illustrated. The method begins with step 302, in which artificial intelligence server 112 receives a query from the medical provider via user device 102 with a conversational interface. The conversational interface presents a text input field or voice input capability through which the medical provider poses questions related to obesity management, cardiometabolic comorbidity treatment, pharmacotherapy selection, patient management strategies, or other clinical decision-making scenarios. The query may seek guidance on medication selection for a patient with specific contraindications, advice on managing treatment-resistant obesity, strategies for addressing patient adherence challenges, approaches to managing cardiometabolic comorbidities in the context of obesity treatment, or interpretation of patient biomarker results. User device 102 transmits the query to artificial intelligence server 112 through application server 106, which manages the communication session and authenticates the medical provider's credentials.

Step 304 involves providing advice to the medical provider based on a large language model trained on training content comprising obesity physiology, obesity pathophysiology, type 2 diabetes, pre-bariatric surgery care, post-bariatric surgery care, metabolic dysfunction-associated steatohepatitis, metabolic dysfunction-associated steatotic liver disease, nonalcoholic fatty liver disease, non-alcoholic steatohepatitis, women's health, polycystic ovary syndrome, and menopausal weight gain. Artificial intelligence server 112 processes the query using natural language processing algorithms to extract the clinical question, identify relevant patient characteristics mentioned in the query, and determine which domain of obesity medicine the query pertains to. The large language model within artificial intelligence server 112 generates a response that addresses the specific clinical question posed by the medical provider. The advice may include recommendations for specific medications with dosing guidance, suggestions for laboratory tests to order for further evaluation, strategies for patient counseling on diet and exercise modifications, approaches to managing side effects of anti-obesity medications, or protocols for transitioning patients between different therapeutic modalities. The large language model draws upon its training on obesity-related medical content to formulate clinically appropriate advice that reflects current evidence-based practices. Artificial intelligence server 112 transmits the generated advice to user device 102 through application server 106, where the advice is displayed in the conversational interface for the medical provider to review.

Following provision of the advice, artificial intelligence server 112 receives outcome information based on the advice at step 306. The outcome information comprises at least one of biomarker information, information about a medication, or diet type information that reflects the clinical results achieved when the medical provider applied the advice to patient care. Biomarker information may include patient weight changes, body mass index changes, hemoglobin A1c values for diabetic patients, lipid panel results, liver function test results, blood pressure measurements, fasting glucose levels, or other quantitative health metrics that indicate treatment effectiveness. Information about a medication may include whether the patient tolerated the medication without significant adverse effects, whether the medication produced the expected therapeutic response, whether dose adjustments were required, whether the patient achieved target weight loss with the medication, or whether the medication was discontinued due to side effects or lack of efficacy. Diet type information may include which dietary intervention the patient followed, the degree of patient adherence to the dietary recommendations, and the weight loss or metabolic improvements achieved with the dietary intervention. The medical provider may manually input outcome information through user device 102 after treating the patient, or database server 108 may automatically extract outcome information from electronic medical record entries, prescription records, and laboratory result feeds. Application server 106 receives the outcome information and routes it to artificial intelligence server 112 for incorporation into the retraining process.

Artificial intelligence server 112 retrains the large language model based on the outcome information at step 308 to provide improved advice for treating a comorbid condition. The retraining process correlates the advice previously provided at step 304 with the outcome information received at step 306 to determine whether the advice led to favorable or unfavorable clinical results. When outcome information indicates positive results, such as significant weight loss, improvement in biomarker values, resolution of comorbid conditions, or high patient satisfaction, artificial intelligence server 112 strengthens the association between the clinical scenario described in the original query and the advice that was provided. This increases the probability that the large language model will provide similar advice when encountering analogous clinical scenarios in future queries. Conversely, when outcome information indicates negative results, such as lack of therapeutic response, adverse medication effects, worsening of biomarker values, or patient discontinuation of treatment, artificial intelligence server 112 weakens the association between the clinical scenario and the advice that was provided. This decreases the probability that the large language model will provide the same advice for similar future queries and prompts the model to explore alternative recommendations. The retraining process updates the weights and parameters of the neural network underlying the large language model to reflect the empirical effectiveness data captured in the outcome information. Over time, as artificial intelligence server 112 accumulates outcome information from numerous medical providers treating numerous patients, the large language model becomes increasingly calibrated to provide advice that produces favorable clinical outcomes in real-world practice rather than merely reflecting theoretical guidelines. The continuous retraining at step 308 creates a feedback loop wherein clinical experience informs the artificial intelligence's recommendations, improving the practical utility of the advice for treating obesity and comorbid conditions.

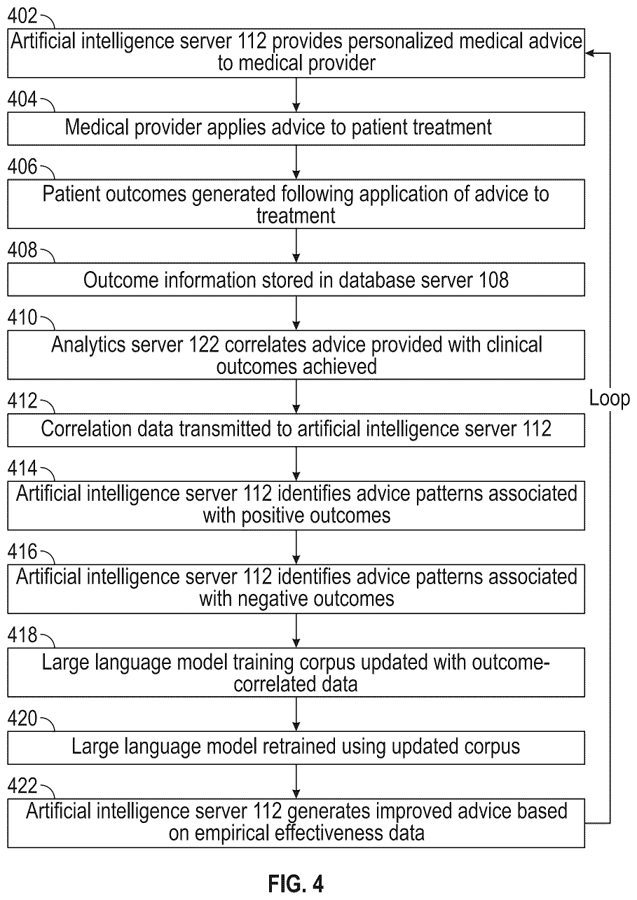

Referring to FIG. 4, an example method for implementing an artificial intelligence retraining feedback loop with outcome correlation is illustrated. This method provides additional detail regarding how artificial intelligence server 112 continuously improves its guidance based on empirical clinical effectiveness data. The method begins with step 402, in which artificial intelligence server 112 provides personalized medical advice to a medical provider via user device 102. The personalized medical advice addresses a specific clinical question or patient management scenario presented by the medical provider through the conversational interface. The advice is generated by the large language model based on its training on obesity-related medical content and any prior outcome-based retraining that has occurred.

At step 404, the medical provider applies the advice to patient treatment. The medical provider prescribes medications, orders laboratory tests, provides patient counseling, implements dietary or exercise interventions, or takes other clinical actions based on the advice received from artificial intelligence server 112. The medical provider documents these clinical actions in the electronic medical record system, creating a record of how the advice was translated into actual patient care. Database server 108 stores the clinical documentation associated with the patient encounter, linking the advice provided by artificial intelligence server 112 to the specific treatment decisions made by the medical provider.

Step 406 involves generation of patient outcomes following application of the advice to treatment. Over subsequent days, weeks, or months, the patient experiences clinical results from the treatment implemented by the medical provider. These outcomes may include weight loss or weight gain, changes in biomarker values such as hemoglobin A1c or lipid levels, resolution or persistence of comorbid conditions, occurrence or absence of medication side effects, patient adherence levels to prescribed treatments, patient satisfaction with care, and overall health status improvements or deteriorations. The patient outcomes are captured through follow-up appointments, laboratory testing, patient-reported outcome surveys, and ongoing clinical monitoring. Database server 108 receives and stores the patient outcome data, associating it with the patient's medical record and the prior clinical encounter where the medical provider applied advice from artificial intelligence server 112.

Outcome information is stored in database server 108 at step 408. The outcome information includes biomarker data such as weight, body mass index, hemoglobin A1c, fasting glucose, lipid panel results, blood pressure, and liver function tests. The outcome information also includes medication effectiveness data indicating whether prescribed anti-obesity medications or medications for comorbid conditions produced the expected therapeutic effects. Diet type information and exercise adherence information are stored, documenting which lifestyle interventions the patient followed and the degree of adherence achieved. Patient satisfaction scores and qualitative patient comments regarding their treatment experience are stored as additional outcome information. Database server 108 structures the outcome information to enable subsequent correlation with the advice that was provided, maintaining links between the original query, the advice generated, the treatment implemented, and the results achieved.

Analytics server 122 correlates advice provided with clinical outcomes achieved at step 410. Analytics server 122 retrieves from database server 108 the advice that artificial intelligence server 112 provided to the medical provider, the treatment actions the medical provider took based on that advice, and the patient outcomes that resulted from the treatment. Analytics server 122 applies statistical analysis and machine learning algorithms to determine whether a causal or associative relationship exists between the specific advice provided and the outcomes achieved. For example, analytics server 122 may determine that when artificial intelligence server 112 recommended a particular anti-obesity medication for patients with specific clinical characteristics, those patients achieved an average weight loss of fifteen percent of initial body weight with minimal side effects. Alternatively, analytics server 122 may determine that when artificial intelligence server 112 recommended a different medication for patients with similar clinical characteristics, those patients achieved only five percent weight loss and frequently discontinued treatment due to gastrointestinal side effects. These correlations quantify the real-world effectiveness of different advice patterns, providing empirical data on which recommendations produce superior clinical outcomes.

The correlation data is transmitted to artificial intelligence server 112 at step 412. Analytics server 122 packages the correlation findings into structured data sets that identify which types of advice led to favorable outcomes, which types of advice led to unfavorable outcomes, and which patient characteristics or clinical scenarios modulate the effectiveness of different recommendations. The correlation data includes statistical confidence measures indicating the strength of evidence supporting each correlation, enabling artificial intelligence server 112 to weight the retraining influence of each correlation appropriately based on the amount and quality of outcome data supporting it.

Artificial intelligence server 112 identifies advice patterns associated with positive outcomes at step 414. The large language model within artificial intelligence server 112 analyzes the correlation data to extract patterns in the types of advice that consistently produced favorable clinical results. These patterns may relate to medication selection strategies, dosing approaches, patient counseling techniques, sequencing of therapeutic interventions, or other aspects of clinical decision-making. For instance, artificial intelligence server 112 may identify that advising gradual dose escalation of certain medications produces better long-term adherence than recommending immediate therapeutic dosing. Or artificial intelligence server 112 may identify that recommending combination therapy for patients with specific comorbidity profiles produces superior weight loss compared to monotherapy approaches.

Conversely, artificial intelligence server 112 identifies advice patterns associated with negative outcomes at step 416. The large language model analyzes the correlation data to determine which types of advice consistently produced unfavorable clinical results such as treatment failures, medication discontinuations due to side effects, lack of weight loss despite treatment, worsening of comorbid conditions, or patient dissatisfaction with care. These negative outcome patterns inform the retraining process by indicating which recommendation strategies should be deprioritized or eliminated from the large language model's response generation algorithms.

Step 418 involves updating the large language model training corpus with outcome-correlated data. Artificial intelligence server 112 incorporates the positive and negative outcome patterns identified at steps 414 and 416 into the training corpus used to train the large language model. The updated training corpus includes not only the original obesity-related medical content comprising textbooks, clinical guidelines, research literature, and expert knowledge, but also the empirical outcome data demonstrating which approaches actually work in clinical practice. This hybrid training corpus combines evidence-based theoretical knowledge with real-world effectiveness data, enabling the large language model to provide advice that is both scientifically grounded and practically validated.

The large language model is retrained using the updated corpus at step 420. Artificial intelligence server 112 executes neural network training algorithms that adjust the weights, parameters, and attention mechanisms of the large language model to better align its outputs with the patterns observed in the outcome-correlated data. The retraining process strengthens the model's tendency to generate advice similar to the advice patterns that produced positive outcomes and weakens the model's tendency to generate advice similar to the advice patterns that produced negative outcomes. The retraining may employ techniques such as reinforcement learning from human feedback, supervised fine-tuning on outcome-labeled examples, or reward modeling that assigns higher values to advice strategies associated with superior clinical outcomes.

Following retraining, artificial intelligence server 112 generates improved advice based on empirical effectiveness data at step 422. When medical providers submit new queries through user device 102, the retrained large language model produces recommendations that reflect not only theoretical best practices but also the accumulated clinical experience of all medical providers using system 100. The improved advice is more likely to produce favorable clinical outcomes because it has been optimized based on thousands of real patient treatment experiences. The method then returns to step 402, with artificial intelligence server 112 providing this improved personalized medical advice to medical providers, creating a continuous feedback loop wherein each cycle of advice provision, outcome collection, correlation analysis, and model retraining progressively enhances the clinical utility of the artificial intelligence system.

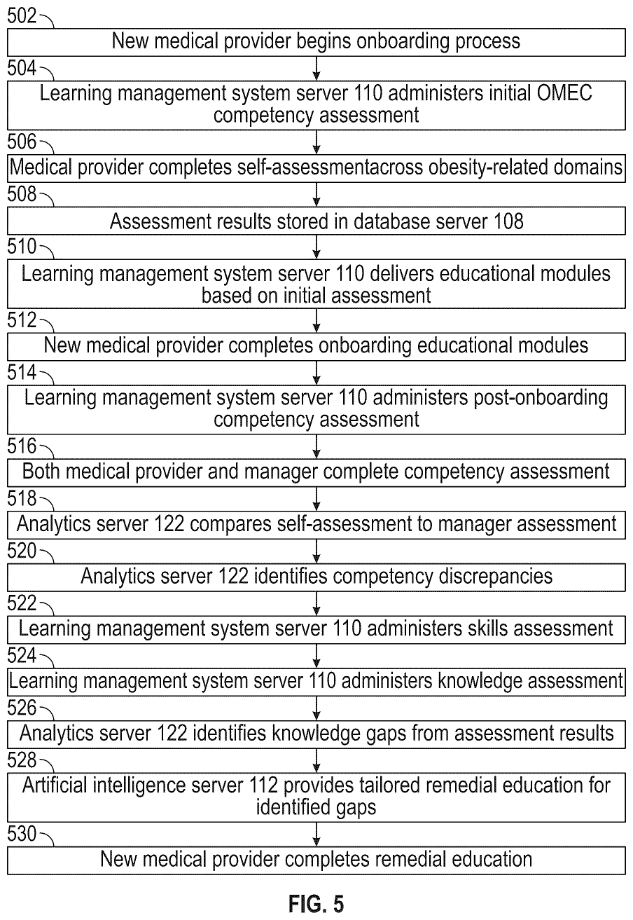

Referring to FIG. 5, an example method for implementing onboarding and initial competency verification workflow is illustrated. This method depicts the initial stages through which new medical providers progress from entry into the organization through completion of foundational training and readiness for clinical practice. The method begins with step 502, in which a new medical provider begins the onboarding process. The new medical provider is assigned access credentials for user device 102 and granted initial access to learning management system server 110. Application server 106 creates a user profile in database server 108 that will track the new medical provider's progress through the onboarding workflow and subsequent competency development stages.

Learning management system server 110 administers an initial Obesity Medicine Educational Collaborative competency assessment at step 504. This assessment presents the new medical provider with a structured questionnaire covering multiple obesity-related domains including obesity physiology, obesity pathophysiology, diabetes management, bariatric surgery care, pharmacotherapy for obesity and comorbid conditions, intensive therapeutic interventions, patient counseling and behavioral modification techniques, nutrition principles, exercise prescription, and management of cardiometabolic comorbidities. For each domain, the new medical provider self-reports their competency level using a rating scale such as novice, advanced beginner, competent, proficient, or expert. The new medical provider may also indicate specific topics within each domain where they have particular expertise or particular knowledge deficits.

At step 506, the new medical provider completes the self-assessment across obesity-related domains. The completion of the self-assessment typically occurs during the first day of the onboarding process, ensuring that subsequent educational content delivery can be tailored to the new medical provider's self-identified needs. Learning management system server 110 analyzes the self-assessment results to identify domains where the new medical provider reported lower competency levels, prioritizing these areas for focused educational intervention during the onboarding process. Database server 108 stores the initial competency assessment results at step 508, establishing a baseline competency profile for the new medical provider. Database server 108 maintains a longitudinal competency assessment record for each medical provider, enabling comparison of competency levels at different time points throughout the medical provider's career. The stored results include not only the overall competency ratings for each domain but also granular responses to individual assessment items, providing detailed insight into specific knowledge strengths and weaknesses.

Learning management system server 110 delivers educational modules based on the initial assessment at step 510. The educational modules are sequenced and prioritized according to the competency gaps identified in the initial assessment. Medical providers who reported novice-level competency in pharmacotherapy receive comprehensive medication education covering mechanisms of action, efficacy data, side effect profiles, contraindications, drug interactions, dosing protocols, and patient counseling approaches for all approved anti-obesity medications and medications used to treat comorbid conditions. Medical providers who reported competent or proficient levels in certain domains receive abbreviated review content for those areas, allowing more time to focus on domains requiring deeper instruction. The personalized module delivery ensures efficient use of onboarding time by concentrating educational effort where it will produce the greatest competency improvements.

The new medical provider completes onboarding educational modules at step 512. Completion requires not only viewing or reading the educational content but also passing knowledge checks embedded within each module. Learning management system server 110 tracks completion status for each required module and prevents progression to subsequent onboarding stages until all assigned modules have been completed successfully. The duration of the module completion phase varies depending on the new medical provider's baseline competency level and the comprehensiveness of the module assignments, but typically ranges from two to four weeks of full-time engagement.

Following module completion, learning management system server 110 administers a post-onboarding competency assessment at step 514. This assessment uses the same Obesity Medicine Educational Collaborative competency framework employed in the initial assessment, enabling direct comparison of pre-onboarding and post-onboarding competency levels. The post-onboarding assessment evaluates whether the educational modules successfully elevated the new medical provider's competency in the targeted domains and whether any unexpected knowledge gaps emerged during the learning process. Both the new medical provider and the manager complete the competency assessment at step 516. The dual-completion approach provides two perspectives on the new medical provider's competency level. The new medical provider completes the assessment as a self-evaluation, rating their own perceived competency in each domain after completing the educational modules. The manager completes the assessment as an external evaluation, rating the new medical provider's competency based on the manager's observations of the new medical provider's performance during training exercises, case discussions, and simulated patient encounters.

Analytics server 122 compares self-assessment to manager assessment at step 518. Analytics server 122 retrieves both assessment data sets from database server 108 and performs domain-by-domain comparison of the competency ratings. When the self-assessment and manager assessment ratings align closely, analytics server 122 concludes that the new medical provider has accurate insight into their own competency levels. When substantial discrepancies exist, analytics server 122 flags these domains for discussion during feedback sessions. Instances where the new medical provider rated themselves as more competent than the manager's rating indicate potential overconfidence that could lead to clinical errors if not addressed. Instances where the new medical provider rated themselves as less competent than the manager's rating indicate underconfidence that may cause unnecessary hesitation in clinical decision-making. Analytics server 122 identifies competency discrepancies at step 520, and the identified discrepancies are transmitted to collaboration server 118, which schedules individual feedback sessions between the new medical provider and the manager to discuss the divergent assessments.

Learning management system server 110 administers a skills assessment at step 522. Unlike the competency assessments which evaluate theoretical knowledge through questionnaires, the skills assessment evaluates practical proficiency through demonstration of actual task execution. Learning management system server 110 presents simulated clinical scenarios requiring the new medical provider to navigate the electronic medical record system, enter patient data, order medications with appropriate dosing and duration, order laboratory tests, document clinical encounters, submit billing codes, generate referrals, and access clinical decision support tools. An evaluator observes the new medical provider performing these tasks and rates the accuracy, efficiency, and appropriateness of task execution. Tasks performed incorrectly or inefficiently are flagged for remediation.

Learning management system server 110 administers a knowledge assessment at step 524. The knowledge assessment differs from both the competency assessment and the skills assessment in that it tests specific medical knowledge through examination questions requiring detailed clinical reasoning. The knowledge assessment presents case vignettes describing patients with obesity and various comorbid conditions, then poses questions about diagnosis, treatment selection, medication dosing, monitoring protocols, and management of complications. The new medical provider must select correct answers from multiple choice options or provide written responses demonstrating appropriate clinical decision-making. Learning management system server 110 scores the knowledge assessment and identifies topic areas where the new medical provider answered questions incorrectly, indicating knowledge deficits requiring remediation.

Analytics server 122 identifies knowledge gaps from assessment results at step 526. Analytics server 122 analyzes the knowledge assessment results stored in database server 108 to determine which specific obesity-related topics the new medical provider has not yet mastered. The knowledge gaps are categorized by clinical domain and prioritized based on the frequency and severity of the errors observed. Critical knowledge gaps that could lead to patient harm if not corrected receive highest priority for immediate remediation.

Artificial intelligence server 112 provides tailored remedial education for identified gaps at step 528. Based on the prioritized knowledge gap list received from analytics server 122, artificial intelligence server 112 selects specific educational resources from learning management system server 110 that address each identified deficiency. The remedial education may include review of educational module sections, completion of additional case studies focusing on the problem topics, consultation with subject matter experts through collaboration server 118, or participation in one-on-one tutoring sessions. Artificial intelligence server 112 personalizes the remedial education approach based on the new medical provider's learning preferences and the nature of the knowledge gap. The new medical provider completes remedial education at step 530. Completion of remedial education is verified through reassessment on the specific topics where knowledge gaps were identified. Learning management system server 110 presents targeted questions addressing the remediated topics and confirms that the new medical provider now demonstrates adequate knowledge before permitting progression to clinical practice.

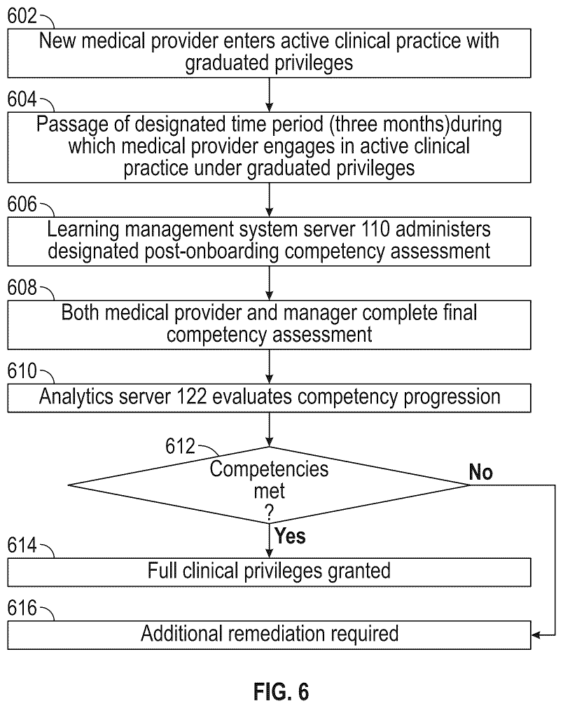

Referring to FIG. 6, an example method for implementing post-onboarding monitoring and privilege expansion workflow is illustrated. This method depicts how medical providers transition from initial training to supervised clinical practice and ultimately to full independent practice privileges based on demonstrated competency. The method begins with step 602, in which the new medical provider enters active clinical practice with graduated privileges following successful completion of all assessments and remediation described in connection with FIG. 5. Graduated privileges means that the new medical provider is authorized to perform certain clinical activities independently while other activities require supervision or co-signature by experienced providers. The specific privileges granted depend on the new medical provider's performance across all assessment modalities. Medical providers who demonstrated strong performance across competency assessments, skills assessments, and knowledge assessments receive broader initial privileges. Medical providers who required extensive remediation or demonstrated persistent weaknesses in certain domains receive more restricted initial privileges, with expansion contingent on demonstrated improvement during supervised practice.

Step 604 involves a passage of a designated time period, such as three months, during which the new medical provider engages in active clinical practice under graduated privileges. During this period, performance audit system 124 continuously monitors the new medical provider's clinical documentation, prescribing patterns, and patient outcomes as described in connection with FIG. 2. The monitoring data accumulates in database server 108, providing empirical evidence of the new medical provider's clinical performance in real-world practice rather than simulated assessment scenarios. The three-month duration provides sufficient time for the new medical provider to encounter a diverse range of patient presentations, comorbidity combinations, and clinical challenges that reveal competency levels more accurately than controlled assessment environments.

Learning management system server 110 administers a designated post-onboarding competency assessment at step 606. This assessment occurs after the designated time period has elapsed, providing clinical experience to either reinforce competencies gained during onboarding or reveal additional weaknesses requiring attention. The designated post-onboarding assessment again uses the Obesity Medicine Educational Collaborative competency framework, enabling longitudinal tracking of competency development across initial assessment, post-onboarding assessment, and designated time period assessment time points. Both the new medical provider and the manager complete the final competency assessment at step 608. The assessment process mirrors the post-onboarding dual assessment approach described in connection with FIG. 5, capturing both self-evaluation and external evaluation perspectives. However, at this stage, both the new medical provider and the manager have the benefit of months of actual clinical performance data to inform their competency ratings, potentially yielding more accurate assessments than those conducted immediately after onboarding before clinical practice commenced.

Analytics server 122 evaluates competency progression at step 610. Analytics server 122 retrieves competency assessment data from all three time points, initial assessment, post-onboarding assessment, and designated time period assessment, and analyzes trajectories of competency development across each obesity-related domain. Medical providers who show consistent improvement across all assessments demonstrate successful onboarding and effective ongoing learning. Medical providers who show stagnation or regression in certain competency domains despite completing educational modules and engaging in clinical practice may require additional interventions such as increased supervision, mentorship arrangements, or enrollment in external continuing education programs. Analytics server 122 applies predetermined competency thresholds established for each domain, evaluating whether the new medical provider's assessment results exceed the minimum competency levels required for independent practice. The competency determination considers not only the absolute competency ratings but also the trajectory of competency development and the degree of alignment between self-assessment and manager assessment.

The method proceeds to step 612, which determines whether competencies are met. Medical providers whose competency levels meet or exceed all established thresholds and who demonstrate accurate self-assessment calibration are deemed ready for full clinical privileges. If the determination at step 612 is affirmative, indicating that competencies are met, the method proceeds to step 614, where full clinical privileges are granted. The new medical provider transitions from graduated privileges to full privileges, gaining authorization to perform all clinical activities within their scope of practice without supervision or co-signature requirements. Database server 108 updates the medical provider's credential profile to reflect the privilege expansion, and application server 106 modifies access controls to enable the expanded clinical functionality. The medical provider continues to be subject to ongoing performance monitoring through performance audit system 124, but the intensity of monitoring may be reduced compared to the graduated privileges phase.

If the determination at step 612 is negative, indicating that competencies are not met, the method proceeds to step 616, where additional remediation is required. The medical provider remains under graduated privileges and receives targeted educational interventions addressing the specific domains where competency deficits persist. The remediation process mirrors the approach described in connection with FIG. 5, with artificial intelligence server 112 selecting tailored educational content from learning management system server 110 to address identified gaps. The additional remediation may involve completion of supplementary educational modules, participation in mentorship arrangements with experienced providers, observation of expert clinician patient encounters, discussion of challenging cases through collaboration server 118, or enrollment in external continuing education programs offering specialized training in deficient domains. Following completion of additional remediation, the medical provider may be reassessed using the same competency assessment framework to determine whether competencies have been elevated to acceptable levels. In cases where multiple remediation cycles fail to elevate competencies to required thresholds, the organization may implement additional measures such as extended supervision periods, role modifications limiting the medical provider to clinical activities within their demonstrated competencies, or separation from clinical practice if fundamental competency deficits cannot be remediated. The graduated privilege expansion model ensures that only medical providers who have demonstrated both theoretical knowledge and practical clinical competence through multiple assessment modalities and real-world performance monitoring receive authorization for independent practice.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “language model” refers to any type of automated agent that communicates via natural language. For instance, a language model can be implemented as a neural network, e.g., a decoder-based generative language model such as versions of ChatGPT, Gemini, Chameleon, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

An example generative language model is now described that can be employed using the disclosed implementations. This generative language model is an example of a machine learning model that can be used to perform one or more natural language processing tasks that involve generating text, as discussed more below. For the purposes of this document, the term “natural language” means language that is normally used by human beings for writing or conversation.

The generative language model can receive input text, e.g., a prompt from a user. For instance, the input text can include words, sentences, phrases, or other representations of language. The input text can be broken into tokens and mapped to token and position embeddings representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings are processed in one or more decoder blocks. Each decoder block implements masked multi-head self-attention, which is a mechanism relating different positions of tokens within the input text to compute the similarities between those tokens. Each token embedding is represented as a weighted sum of other tokens in the input text. Attention is only applied for already-decoded values, and future values are masked. Layer normalization normalizes features to mean values of 0 and variance to 1, resulting in smooth gradients. A Feed forward layer transforms these features into a representation suitable for the next iteration of decoding, after which another layer normalization is applied. Multiple instances of decoder blocks can operate sequentially on input text, with each subsequent decoder block operating on the output of a preceding decoder block. After the final decoding block, a text prediction layer can predict the next word in the sequence, which is output as output text in response to the input text and also fed back into the language model. The output text can be a newly-generated response to the prompt provided as input text to the generative language model.

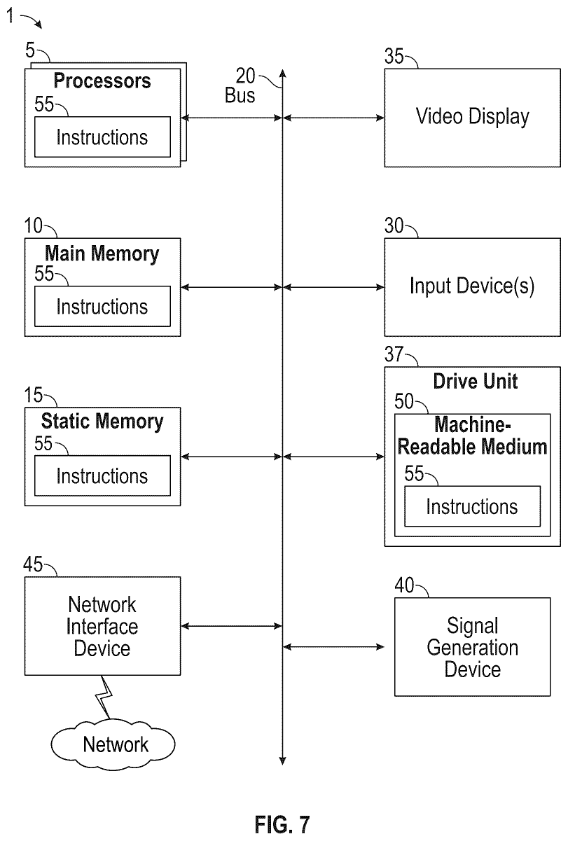

FIG. 7 (in view of FIG. 1) is a diagrammatic representation of an example machine in the form of a computer system 1, within which a set of instructions for causing the machine to perform any one or more of the methodologies discussed herein may be executed. An example computing device 1 suitable for implementing the functionality of user device 102, application server 106, database server 108, learning management system server 110, artificial intelligence server 112, collaboration server 118, analytics server 122, or performance audit system 124 is illustrated. Computing device 1 includes one or more processors 5, which may comprise a central processing unit, a graphics processing unit, or both. Processors 5 execute instructions 55 to perform the operations described herein. Computing device 1 further includes main memory 10 and static memory 15, which communicate with processors 5 via bus 20. Main memory 10 and static memory 15 store instructions 55 and data used during operation of computing device 1.

Computing device 1 may include video display 35, such as a liquid crystal display, for presenting information to users. Computing device 1 may also include alpha-numeric input devices 30, such as a keyboard, and a cursor control device, such as a mouse, for receiving user input. A voice recognition or biometric verification unit may also be included for authentication purposes. Drive unit 37 includes machine-readable medium 50 on which instructions 55 and data structures are stored. Instructions 55 embody the methodologies and functions described herein. Machine-readable medium 50 may comprise a single medium or multiple media, such as a centralized or distributed database and associated caches and servers. Instructions 55 may also reside, completely or at least partially, within main memory 10 and within processors 5 during execution by computing device 1.

Signal generation device 40 generates audio or visual signals for output to users. Network interface device 45 enables computing device 1 to communicate with other computing devices over a network. Instructions 55 may be transmitted or received over the network via network interface device 45 utilizing transfer protocols such as Hyper Text Transfer Protocol. Computing device 1 may be implemented using commercially available hardware platforms with appropriate software installed, or may be implemented using application specific integrated circuits or microcontrollers programmed to carry out the operations described herein.

In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present disclosure. However, it will be apparent to one skilled in the art that the present disclosure may be practiced in other embodiments that depart from these specific details.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A system for training medical providers in obesity management and obesity-related comorbidities, the system comprising:
a user device configured to present a conversational interface to a medical provider;
an application server in communication with the user device, the application server configured to manage user sessions and process requests from the user device;
a database server in communication with the application server, the database server configured to store user data comprising course completion records, knowledge assessment results, and clinical performance audits;
a learning management system server in communication with the application server, the learning management system server configured to deliver educational modules based on established competencies and to track user progress through the educational modules;
an artificial intelligence server in communication with the application server, the artificial intelligence server configured to process queries from the medical provider and provide personalized medical advice using a large language model trained on obesity-related medical content comprising obesity physiology, pharmacotherapy, and patient management, wherein the artificial intelligence server is further configured to receive outcome information related to patient health metrics following the personalized medical advice and to retrain the large language model based on the outcome information; and
a performance audit system in communication with the application server, the performance audit system configured to monitor clinical documentation, prescribing patterns, and patient outcomes of the medical provider.

2. The system of claim 1, wherein the database server comprises a combination of relational databases and NoSQL databases.

3. The system of claim 1, further comprising a cloud hosting layer providing scalable storage and processing capabilities for the application server, the database server, the learning management system server, the artificial intelligence server, and the performance audit system.

4. The system of claim 3, further comprising a security layer compliant with Health Insurance Portability and Accountability Act regulations, the security layer configured to protect data through encryption for data at rest and in transit.

5. The system of claim 1, further comprising a collaboration server configured to facilitate real-time communication between the medical provider and subject matter experts through Health Insurance Portability and Accountability Act compliant chat channels and video conferencing.

6. The system of claim 5, further comprising a feedback and frequently asked questions module in communication with the collaboration server, the feedback and frequently asked questions module configured to compile questions and responses to create a dynamic knowledge base.

7. The system of claim 1, further comprising an analytics server in communication with the application server, the analytics server configured to process data comprising course completions, assessment scores, and clinical practice audits to generate insights into training effectiveness.

8. The system of claim 7, wherein the analytics server is configured to apply machine learning algorithms to identify knowledge gaps and inform personalized feedback for the medical provider.

9. The system of claim 1, wherein the learning management system server is configured to administer a series of educational modules based on Obesity Medicine Educational Collaborative competencies during an onboarding process.

10. The system of claim 9, wherein the learning management system server is configured to conduct assessments at a beginning of the onboarding process, after the onboarding process, and at a designated time post-onboarding to evaluate competencies of the medical provider in obesity-related domains.

11. The system of claim 1, wherein the learning management system server is configured to perform a skills assessment to verify proficiency of the medical provider in performing tasks within an electronic medical record system.

12. The system of claim 1, wherein the performance audit system is configured to evaluate quality of patient care and identify areas where additional training is required and trigger educational interventions.

13. The system of claim 1, wherein the obesity-related medical content further comprises type 2 diabetes, pre-bariatric surgery care, post-bariatric surgery care, metabolic dysfunction-associated steatohepatitis, metabolic dysfunction-associated steatotic liver disease, nonalcoholic fatty liver disease, non-alcoholic steatohepatitis, women's health, polycystic ovary syndrome, and menopausal weight gain.

14. A method for training medical providers in obesity treatment and obesity-related comorbidities, the method comprising:
administering, by a learning management system server, a series of educational modules based on Obesity Medicine Educational Collaborative competencies during an onboarding process for a new medical provider;
conducting, by the learning management system server, assessments at a beginning of the onboarding process, after the onboarding process, and at a designated time post-onboarding to evaluate competencies of the new medical provider in obesity-related domains;
performing, by the learning management system server, a skills assessment to verify proficiency of the new medical provider in performing tasks within an electronic medical record system and clinical protocols;
providing, by an artificial intelligence server, tailored remedial education based on gaps identified during a knowledge assessment; and
continuously auditing, by a performance audit system, clinical documentation, prescriptions, and patient interactions of the new medical provider to ensure ongoing compliance and performance improvements.

15. The method of claim 14, further comprising processing, by the artificial intelligence server, queries from the new medical provider using a large language model trained on obesity-related medical content.

16. The method of claim 15, further comprising retraining, by the artificial intelligence server, the large language model based on outcome information related to patient health metrics to improve accuracy of future advice.

17. The method of claim 14, wherein the obesity-related domains comprise obesity physiology, diabetes management, bariatric surgery care, and cardiometabolic comorbidities.

18. A system for training a medical provider in treating obesity and obesity-related comorbidities, the system comprising:
at least one processor; and
a memory storing instructions that, when executed by the at least one processor, cause the system to:
receive, from the medical provider via a user-facing application with a conversational interface, a query;
provide advice to the medical provider based on a large language model trained on training content comprising obesity physiology, obesity pathophysiology, type 2 diabetes, pre-bariatric surgery care, post-bariatric surgery care, metabolic dysfunction-associated steatohepatitis, metabolic dysfunction-associated steatotic liver disease, nonalcoholic fatty liver disease, non-alcoholic steatohepatitis, women's health, polycystic ovary syndrome, and menopausal weight gain;
receive outcome information based on the advice, wherein the outcome information comprises at least one of biomarker information, information about a medication, or diet type information; and
retrain the large language model based on the outcome information for improved advice for treating a comorbid condition.

19. The system of claim 18, wherein the large language model comprises a neural network.

20. The system of claim 18, wherein the conversational interface is configured to understand and analyze the query with medical accuracy.
